(19) United States
(12) Patent Application Publication
(10) Pub. No.: US 2026/0170948 A1
(43) Pub. Date: Jun. 18, 2026

(54) VEHICLE-ROAD DRIVING INTELLIGENCE ALLOCATION

(71) Applicant: CAVH LLC, Fitchburg, WI (US)

(72) Inventors: Bin Ran, Fitchburg, WI (US); Tianyi Chen, Madison, WI (US); Yang Cheng, Middleton, WI (US); Xiaotian Li, Madison, WI (US); Shen Li, Madison, WI (US); Kunsong Shi, Madison, WI (US); Zhen Zhang, Madison, WI (US); Yang Zhou, Madison, WI (US); Shuoxuan Dong, Madison, WI (US); Fan Ding, Madison, WI (US); Huachun Tan, Madison, WI (US)

(21) Appl. No.: 19/530,979

(22) Filed: Feb. 5, 2026

Related U.S. Application Data
(63) Continuation of application No. 17/977,347, filed on Oct. 31, 2022, now Pat. No. 12,555,471.
Application No. 17/977,347 is a continuation of application No. 16/406,621, filed on May 8, 2019, now Pat. No. 11,495,126.
(60) Provisional application No. 62/669,215, filed on May 9, 2018.

(51) Int. Cl. G08G 1/01; G05B 13/02; G05D 1/00; G08G 1/0967

(52) U.S. Cl. CPC G08G 1/0145; G05B 13/0265; G08G 1/0112; G08G 1/0116; G08G 1/0125; G08G 1/0133; G08G 1/096708; G08G 1/096725; G08G 1/096741; G08G 1/096775; G08G 1/164; G08G 1/166

(57) ABSTRACT

The present technology relates to systems and methods that allocate, arrange, and distribute certain types of functions and intelligence for autonomous driving systems (ADS) to facilitate vehicle operations and controls; to improve the safety of an autonomous vehicle (AV); and to ensure the efficiency, intelligence, reliability, and resilience of ADS. The present technology also provides methods to define ADS system intelligence and its levels, which are based on two dimensions: the vehicle intelligence and the cloud intelligence. The cloud intelligence supports and complements the vehicle intelligence when a vehicle is impaired or handicapped for certain functions (sensing, prediction, decision, and/or control) during operations in abnormal conditions. Distribution of driving intelligence between the AV and the cloud facilitates safe operations of the AV for long-tail corner cases.

This application is a continuation of U.S. patent application Ser. No. 17/977,347, filed Oct. 31, 2022, now U.S. Pat. No. 12,555,471, issued on Feb. 17, 2026, which is a continuation of U.S. patent application Ser. No. 16/406,621, filed May 8, 2019, now U.S. Pat. No. 11,495,126, issued on Nov. 8, 2022, which claims the benefit of U.S. Provisional Patent Application No. 62/669,215, filed May 9, 2018, each of which is incorporated herein by reference in its entirety.

### FIELD

The present invention relates to systems and methods that allocate, arrange, and distribute certain types of functions and intelligence, for connected automated vehicle highway (CAVH) systems, to facilitate vehicle operations and controls, to improve the general safety of the whole transportation system, and to ensure the efficiency, intelligence, reliability, and resilience of CAVH systems. The present invention also provides methods to define CAVH system intelligence and its levels, which are based on two dimensions: the vehicle intelligence and infrastructure intelligence.

### BACKGROUND

Autonomous vehicles, which are capable of sensing the environment, detecting obstacles, and navigating without human effort, are in development stage. Presently, autonomous vehicles have been put into field tests, but they have not been put into wide-spread commercial use. Existing approaches for autonomous vehicles require expensive and complicated on-board systems, multiple sensing systems, and highly rely on the vehicle sensors and control, which makes their implementation a substantial challenge.

Alternative systems and methods that address these problems are describe in U.S. patent application Ser. No. 15/628,331, filed Jun. 20, 2017, and U.S. Provisional Patent Application Ser. No. 62/626,862, filed Feb. 6, 2018, 62/627,005, filed Feb. 6, 2018, and 62/655,651, filed Apr. 10, 2018, the disclosures of which are herein incorporated by reference in their entireties (referred to herein as a CAVH system).

The inventions described herein provide systems and intelligence allocation methods for different combination of Intelligent Road Infrastructure System (IRIS) and vehicle automation to achieve transportation and vehicle systems performance, which facilitates vehicle operations and control for automated vehicle highway (CAVH) systems to behave optimally and robustly. The description below describes the general CAVH system and intelligence allocation methods to achieve certain system performance, and provides illustrative detailed methods for this vehicle and transportation integrated system.

### SUMMARY

The present invention relates to systems and methods that allocate, arrange, and distribute certain types of functions and intelligence, for connected automated vehicle highway (CAVH) systems, to facilitate vehicle operations and controls, to improve the general safety of the whole transportation system, and to ensure the efficiency, intelligence, reliability, and resilience of CAVH systems. The present invention also provides methods to define CAVH system intelligence and its levels, which are based on two dimensions: the vehicle intelligence and infrastructure intelligence.

For example, in some embodiments, provided herein is a connected and automated vehicle highway (CAVH) system comprising sensing, communication, and control components connected through segments and nodes that manage an entire transportation system. In some embodiments, the vehicles managed within the CAVH system comprise CAVH vehicles and non-CAVH vehicles. In some embodiments, the CAVH vehicles and non-CAVH vehicles comprise manual vehicles, automated vehicles, and connected vehicles.

In some embodiments, the segments and nodes have overlapping sensing and control areas with neighboring segment and nodes to hand off CAVH vehicles between neighboring segments and nodes.

In some embodiments, the CAVH system comprises four control levels: a) vehicle; b) road side unit (RSU); c) traffic control unit (TCU); and d) traffic control center (TCC).

In some embodiments, the vehicle control level comprises vehicles having on on-board system or application to operate a vehicle dynamic system to achieve on-road coordinate commands from an RSU.

In some embodiments, the RSU level involves segments or nodes managed by an RSU responsible for the sensing and control of vehicles. In some embodiments, the sensing comprising information from LiDAR and/or radar sensors or employs computer vision or other related systems that are deployed to fully capture information in a segment or node. In some embodiments, the RSU, in response to the sensing, manages collision avoidance, routing execution, lane change coordination, and high-resolution guidance commands in terms of on-road coordinates for vehicles to execute their automated driving.

In some embodiments, the TCU level involves multiple RSUs manages by a TCU. In some embodiments, the TCU is responsible for updating a dynamic map of moving objects and coordinated control among RSUs for continuous automated driving. In some embodiments, multiple TCUs are connected through TCCs to cover a region or subnetwork.

In some embodiments, the TCC level comprises high-performance computing and cloud services responsible for managing overall routing plans and updating a dynamic map of congestion, incidents, inclement weather, and events with regional impact. In some embodiments, the TCC level is further responsible for managing connecting with other application services including, but not limited to, payment and transaction systems, regional traffic management centers (TMCs), and third-party applications (e.g., government applications, private corporate applications, etc.). In some embodiments, multiple TCCs are employed to facilitate CAVH driving between or across large metropolitan areas.

For example, in some embodiments, provided herein is a connected and automated vehicle highway (CAVH) system comprising sensing, communication, and control components that allocate, arrange, and distribute functions and intelligence that facilitate vehicle operations and controls. In some embodiments, the components improve safety of a transportation system comprising the components. In some embodiments, the components improve efficiency, intelligence, reliability, and/or resilience of the CAVH systems. In some embodiments, the allocated functions comprise sensing. In some embodiments, the allocated functions comprise transportation behavior prediction and management. In some embodiments, the allocated functions comprise planning and decision making. In some embodiments, the allocated functions comprise vehicle control.

In some embodiments, the CAVH system that comprises the sensing, communication, and control components that allocate, arrange, and distribute functions and intelligence that facilitate vehicle operations and controls comprises one or more subsystems: a) an intelligent road infrastructure system (IRIS) comprising one or more of roadside units (RSUs), network and Traffic Control Units (TCUs), and Traffic Control Centers (TCCs); and b) vehicles with an onboard unit (OBU).

In some embodiments, the CAVH system is supported by one or more of: a) real-time communication via wired and wireless media; b) a power supply network; and c) a cyber safety and security system.

In some embodiments, the allocation of functions and intelligence that facilitate vehicle operations and controls is based on the following dimensions: a) vehicle dimension; b) infrastructure dimension; and c) system dimension.

In some embodiments, the system is configured to manage functions and intelligence in any one of a combination of different automation levels at each of the dimensions. In some embodiments, the system is configured to assess a particular level of automation present at any dimension and to select the appropriate allocation of functions and intelligence to optimally manage infrastructure and vehicles operating under such conditions.

In some embodiments, the vehicle dimension comprises the following levels of automation: a) A0: No automation functions; b) A1: Basic functions to assist a human driver controlling a vehicle; c) A2: Assists human driver controlling a vehicle for simple tasks and has basic sensing functions; d) A3: Functions to sense the environment in detail and in real-time, and can handle relative complicated driving task; e) A4: Functions to allow vehicles driving independently under limited conditions and sometimes with human drivers' backup; and f) A5: Functions to allow vehicles driving independently without human drivers' backup for all conditions.

In some embodiments, the infrastructure dimension comprises the following levels of automation: a) I0: No functions; b) I1: Information collection and traffic management wherein the infrastructure provides primitive sensing functions in terms of aggregated traffic data collection and basic planning and decision making to support simple traffic management in low spatial and temporal resolution; c) I2: I2X and vehicle guidance for driving assistance, wherein, in addition to functions provided in I1, the infrastructure realizes limited sensing functions for pavement condition detection and vehicle kinematics detection, such as lateral/longitudinal position/speed/acceleration, for a portion of traffic, in seconds or minutes; the infrastructure also provide traffic information and vehicle control suggestion and instructions for the vehicle through I2X communication; d) I3: Dedicated lane automation, wherein the infrastructure provides individual vehicles with dynamics of surrounding vehicles and other objectives in milliseconds, and supports full automated driving on CAVH-compatible vehicle dedicated lanes; the infrastructure has limited transportation behavior prediction capability; I4: Scenario-specific automaton wherein the infrastructure provides detailed driving instructions for vehicles to realize full automation driving on certain scenarios/areas, such as locations such as predefined geo-fenced areas, where the traffic is mixed by CAVH compatible and non-compatible vehicles; essential vehicle-based automation capability, such as emergency braking, is standing by as a backup system in case the infrastructure fails; and f) I5: Full infrastructure automation wherein infrastructure provides full control and management for individual vehicles for all scenarios and optimizes a whole network where the infrastructure is deployed; vehicle automation functionality is not necessary as a backup; full active safety functions are available.

In some embodiments, the system dimension comprises the following levels of automation: a) S0: no function; b) S1: the system maintains a simple function for individual vehicle such as cruise control and passive safety function; the system detects the vehicle speed and distance; c) S2: the system behaves with individual intelligence and detects vehicle functioning status, vehicle acceleration, traffic sign and signal; individual vehicles make decisions based on their own information, and have partial driving automation complicated functions such as assisting the vehicle's adaptive cruise control, lane keeping, lane changing, and automatic parking; d) S3: the system integrates information between a group of vehicles, and behaves with ad-hoc intelligence with prediction capability, the system has intelligence for decision making for the group of vehicles and can handle complicated conditional automation driving tasks such as cooperative cruise control, vehicle platooning, vehicle passing intersection, merging, and diverging; e) S4: the system integrates driving behavior optimally within a partial network; the system detects and communicates detailed information within the partial network, and makes decisions based on both vehicle and transportation information within the network and handles high driving automation tasks such as passing signal corridors and provides optimal trajectory within a small transportation network; f) S5: vehicle automation and system traffic automation, wherein the system behaves optimally within a whole transportation network; the system detects and communicates detailed information within the large transportation network, and makes decisions based on all available information within the network; the system handles full driving automation tasks including individual vehicle task, transportation tasks, and coordinates all vehicles.

In some embodiments, the system dimension is dependent on the two dimensions: 1) vehicle; and 2) infrastructure, represented by the following equation (S=system automation; V=vehicle intelligence; and I=infrastructure intelligence): S=f(V,I). In some embodiments, the equation is a non-linear function, wherein system automation level 2, comprises, for example: a) Sensing: the vehicle sub-system dominates; the infrastructure sub-system helps to complete the driving environment; b) Transportation behavior prediction and management: the vehicle sub-system dominates; the infrastructure sub-system mainly coordinated with vehicle sub-system; c) Planning and decision making: the vehicle sub-system is a major part; the infrastructure sub-system optimizes the system from a global perspective; and d) Vehicle control: the vehicle sub-system is dominant; the infrastructure sub-system supports vehicle control command.

The systems may be implemented under a variety of different method, depending on the level of automation present in the different dimensions. For example, in some embodiments (method 1), the control components allocate, arrange, and distribute intelligence such that functions are assigned to vehicles, wherein automated vehicles and infrastructure have no communication and function independently and wherein the infrastructure provides no improvement upon vehicle intelligence, which may be applied to an S1 scenario.

In other embodiments (method 2), the control components allocate, arrange, and distribute intelligence such that functions are mostly allocated into vehicle subsystems, and vehicles play a dominant role; wherein a road side device subsystem only takes supplementary responsibility for simple tasks and helps the vehicles maintain certain speeds and provide collision warnings; wherein when there is control decision conflict, the vehicles make a decision; which may be applied to S1 or S2 scenarios.

In other embodiments (method 3) control components allocate, arrange, and distribute intelligence such that functions are flexibly assigned to both vehicle and infrastructure subsystems; wherein either infrastructure or vehicle subsystems play a dominant role in sensing and decision making; wherein a road side device subsystem helps vehicles to make decisions based on local environment, to make control suggestions for vehicles to operate for: a) following strategies, b) lane keep strategies, c) lane changing strategies, d) merging and diverging strategies, and e) passing intersections; wherein when there is control decision conflict, the vehicle makes a control decision either made by itself or using information from the infrastructure; which may be applied to S2 or S3 scenarios.

In other embodiments (method 4), control components allocate, arrange, and distribute intelligence such that functions are mostly distributed to a road side device subsystem, and infrastructure plays a dominant role in control decisions; wherein vehicle subsystems still have basic functions such as collision avoidance; wherein vehicles follow all information provided by the infrastructure, and wherein when there is control decision conflict, the vehicles make control decisions made by the infrastructure; which may be applied to S3 or S4 scenarios.

In other embodiments (method 5) control components allocate, arrange, and distribute intelligence such that all functions rely on a road side subsystem and vehicles have the capability to communicate and follow orders; wherein all vehicles are controlled by the infrastructure system and wherein decisions are made by and communicated with the system through a road side devices network, which may be applied to S4 or S5 scenarios.

In some embodiments, the control components manage a mixed traffic flow of vehicles at different levels of connectivity and automation. In some embodiments, the control components collect vehicle generated data, such as vehicle movement and condition, sends collected data to RSUs, and receives inputs from an IRIS; wherein based on the inputs from the IRIS, an OBU facilitates vehicle control; wherein if a vehicle control system fails, the OBU may take over in a short time period to stop the vehicle safely.

In some embodiments, the IRIS facilitates vehicle operations and control for a CAVH systems; wherein said IRIS provides individual vehicles with detailed customized information and time-sensitive control instructions for vehicles to fulfill driving tasks, such as car following, lane changing, and route guidance; and provides operations and maintenance services for vehicles on both freeways and urban arterials.

In some embodiments, the IRIS is built and managed as an open platform and its own subsystems, as listed below, are owned and/or operated by different entities, and are shared among different CAVH systems physically and/or logically, including one or more or all of the following physical subsystems: a. a roadside unit (RSU) network, whose functions include sensing, communication, control (fast/simple), and drivable ranges computation; b. a Traffic Control Unit (TCU) and Traffic Control Center (TCC) network; c. vehicle onboard units (OBU) and related vehicle interfaces; d. traffic operations centers; and e. cloud-based platform of information and computing services. In some embodiments the system realizes one or more of the following function categories: i. sensing; ii. transportation behavior prediction and management; iii. planning and decision making; and iv. vehicle control.

The systems and methods may include and be integrated with functions and components described in U.S. patent application Ser. No. 15/628,331, filed Jun. 20, 2017, and U.S. Provisional Patent Application Ser. No. 62/626,862, filed Feb. 6, 2018, 62/627,005, filed Feb. 6, 2018, and 62/655,651, filed Apr. 10, 2018, the disclosures of which are herein incorporated by reference in their entireties.

Also provided herein are methods employing any of the systems described herein for the management of one or more aspects of traffic control. The methods include those processes undertaken by individual participants in the system (e.g., drivers, public or private local, regional, or national transportation facilitators, government agencies, etc.) as well as collective activities of one or more participants working in coordination or independently from each other.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

### DRAWINGS

FIG. 1 provides a graph showing the non-linear combination levels of system automation and intelligence.

FIG. 2 shows two and three dimensional graphs of system intelligence levels plotting system automation level versus vehicle automation level and infrastructure automation level.

FIG. 3 shows an exemplary vehicle subsystem.

FIG. 4 shows an exemplary IRIS configuration.

FIG. 5 shows an exemplary AV-only approach.

FIG. 6 shows an exemplary V2V- and V2I-based approach.

FIG. 7 shows an exemplary CAVH approach.

FIG. 8 shows an exemplary intelligence allocation approach at Level 2 system intelligence.

FIG. 9 shows an exemplary flow chart of vehicle control.

### DETAILED DESCRIPTION

Exemplary embodiments of the technology are described below. It should be understood that these are illustrative embodiments and that the invention is not limited to these particular embodiments.

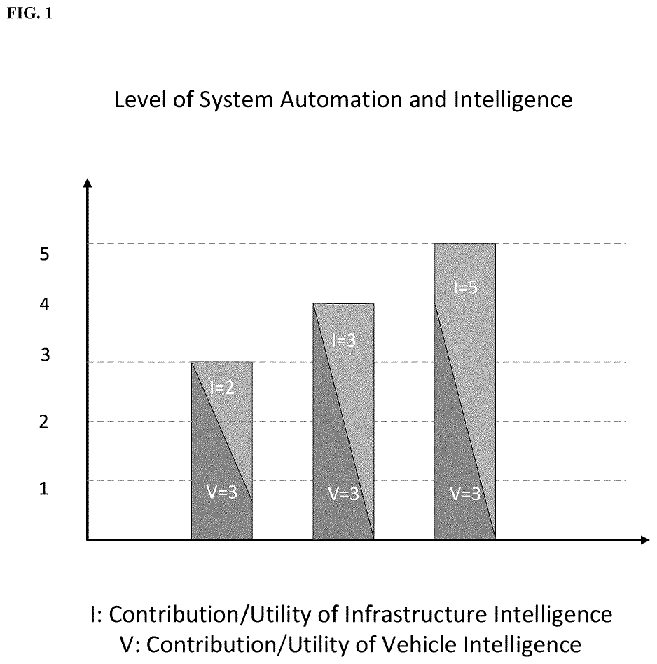

FIG. 1 provides a graph showing that the automation level of the system is the combination of the vehicle automation level and infrastructure automation level. The level of the global system is not limited to a direct combination of the degrees of both subsystems. The functions of the global system are distributed to vehicle sub-systems and infrastructure sub-systems.

This system realizes following function categories: a) Sensing; b) Transportation behavior prediction and management; c) Planning and decision making; and d) Vehicle control.

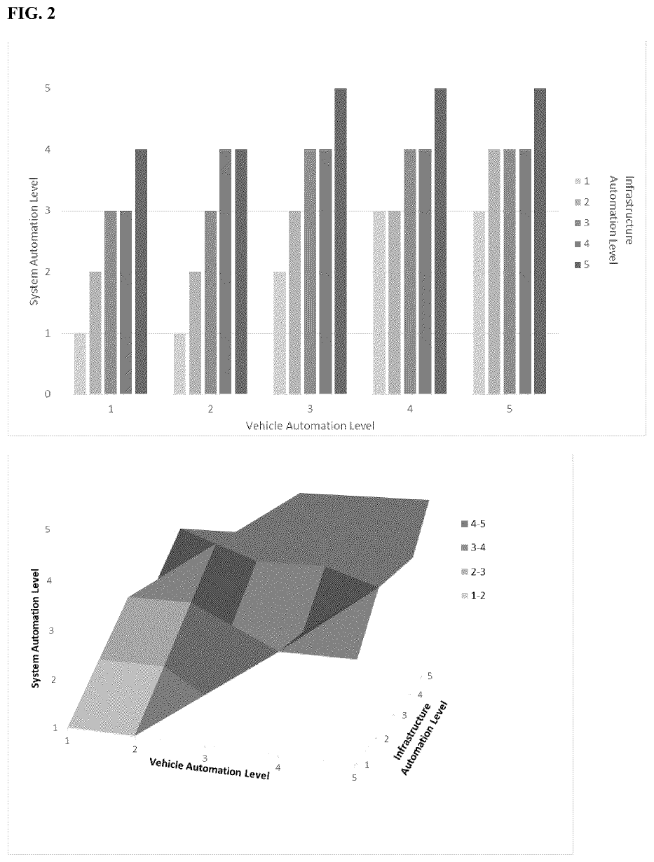

FIG. 2 shows two- and three-dimensional graphs showing the relationship between system automation level relative to vehicle automation level and infrastructure automation level. Table 1 below provides an additional representation with the numbers in each row and column representing the system dimension for each vehicle and infrastructure automation level combination.

TABLE 1
Exemplary system intelligence level determination

| | | Vehicle Automation Level | | | | |
|---|---|---|---|---|---|---|
| | | 1 | 2 | 3 | 4 | 5 |
| Infrastructure | 1 | 1 | 1 | 2 | 3 | 3 |
| Automation Level | 2 | 2 | 2 | 3 | 3 | 4 |
| | 3 | 3 | 3 | 4 | 4 | 4 |
| | 4 | 3 | 4 | 4 | 4 | 4 |
| | 5 | 4 | 4 | 5 | 5 | 5 |

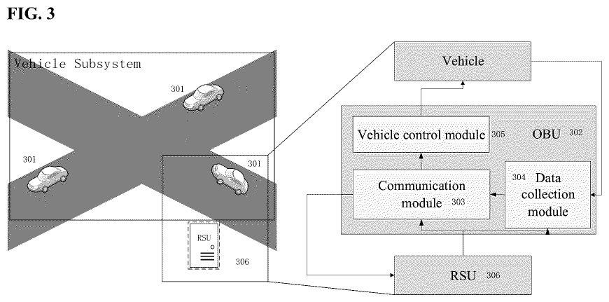

FIG. 3 shows an exemplary vehicle subsystem having components:
301—Vehicle.
302—OBU: on-board unit that controls the vehicle and collects and sends data.
303—Communication module: that transfers data between RSUs and the OBU.
304—Data collection module: that collects data of the vehicle dynamic and static state and generated by humans.
305—Vehicle control module: that executes control commands from RSUs. When the control system of the vehicle is damaged, it can take over control and stop the vehicle safely.
306—RSU: roadside units that collect and send data.

As shown in FIG. 3, a vehicle subsystem comprises all vehicles 301 in CAVH system. For each vehicle, the OBU 302 contains a communication module 303, data collection module 304, and vehicle control module 305. The data collection module collects data from the vehicle and inputs from human drivers, and then sends it to RSU 306 through the communication module. Also, the OBU receives data of the RSU through the communication module. Based on the data from the RSU, the vehicle control module assists to control the vehicle.

FIG. 1 shows an exemplary Intelligent Road Infrastructure System (IRIS) having components:
401—Macroscopic TCC/TOC: highest-level TCC/TOC that manages regional TCCs.
402—Regional TCC: high-level TCC that manages corridor TCCs.
403—Corridor TCC: mid-level TCC that manages segment TCUs.
404—Segment TCU: low-level TCU that manages point TCUs.
405—Point TCU: lowest-level TCU that manages RSUs.

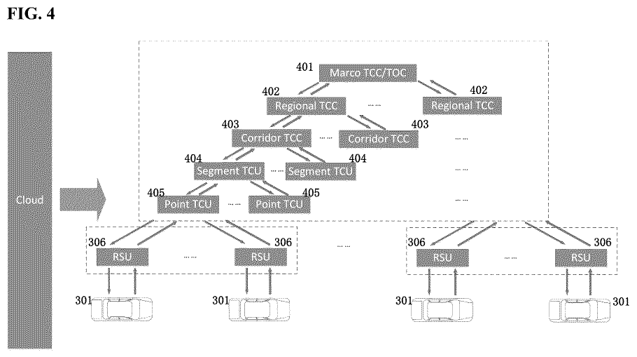

FIG. 4 shows the structure of an exemplary IRIS. A macroscopic TCC 401, which may or may not collaborate with an external TOC 401, manages a certain number of regional TCCs 402 in its coverage area. Similarly, a regional TCC manages a certain number of corridor TCCs 403, a corridor TCC manages a certain number of segment TCUs 404, a segment TCU manages a certain number of point TCUs 405, and a point TCUs manages a certain number of RSUs 306. An RSU sends customized traffic information and controls instructions to vehicles 301 and receives information provided by vehicles. Moreover, in the example shown, the IRIS is supported by cloud services.

Three exemplary approaches comprise:
1. Autonomous vehicles approach;
2. Connected and automated vehicles approach, with the assistance of V2I and V2V technologies; and
3. CAVH-IRIS, infrastructure-based approach with sensing, prediction, and decision making from roadside systems.

Approach 1 has decades of history. There are several exemplary methods to support this approach, such as those described in U.S. Pat. No. 9,120,485 (The autonomous vehicle is configured to follow a baseline trajectory. The vehicle's computer system receives changes to trajectory and optimizes new trajectory for the vehicle), U.S. Pat. No. 9,665,101 (The system determines a route from a current location to a destination for the vehicle), and U.S. Pat. No. 9,349,055 (Used for the Google autonomous vehicle to detect other vehicles when it tries to sense the environment), and US Publ. No. 20170039435 (Used for the Google autonomous vehicle to detect traffic signals when it tries to sense the environment), each of which is herein incorporated by reference in their entireties. The products and their technologies developed by vehicle manufactures and A1 research groups have been implemented. However, the approach lacks the planning and decision-making from the perspective of global optimization. The human drivers can be substituted by autonomous driving A1 but cannot achieve better performance in terms of transportation systems. The approach also suffers from insufficient sensing range, insufficient computing capabilities of the vehicles, and does not suffice to address the complexity and limit that will be confronted in the future.

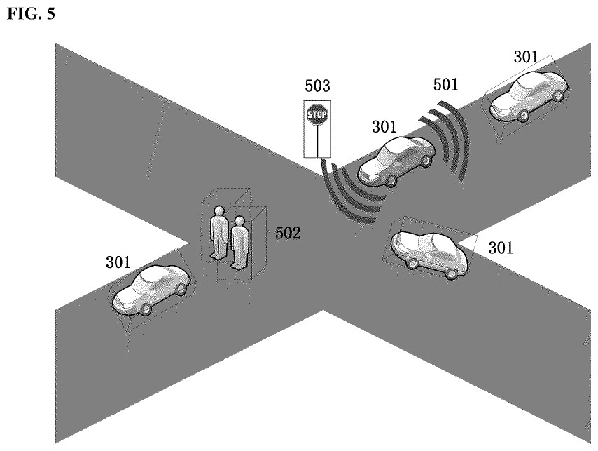

FIG. 5 shows and exemplary AV-Only Approach having components:
501—Sensors on vehicles.
502—Pedestrians on road.
503—Roadside infrastructures.

FIG. 5 shows how automated vehicles 301 work in this approach. The AV is continuously sensing the environment with multiple sensors 501 when it is on the road. The environment includes other vehicles 301 around it, the pedestrians 502, the road infrastructures 503 and others. In this example, the AV detects the two pedestrians in front of it, the three vehicles around it, and a stop sign at the intersection. With the information it obtains, the AV make decisions and operates properly and safely on the road.

Connected and automated vehicles approach, with the assistance of communications. The approach has been attempted for a few years. Some prototypes are already developed, such as those described in US 2012/0059574 (The vehicle unit transmits a vehicle speed to the roadside unit, when in wireless communication range.

The roadside unit transmits the vehicle speed to the traffic controller. The traffic controller receives vehicle speed data from a plurality of vehicles, and determines a suggested speed for each vehicle) and U.S. Pat. No. 7,425,903 (In this grid system, a motor vehicle is equipped with a transmitter, receiver, computer and a selection of sensors. Other adjacent vehicles also contain the same of equipment for transmitting and receiving signals. When the sensors in a vehicle detect a change such as hard braking (rapid deceleration) or very slow speed (blockages), it automatically sends this information via the transmitter over a wireless communication channel to any other receivers in the vicinity), herein incorporated by reference in their entireties. With V2V and V2I communication technologies, the system can make relatively better performance than individual autonomous vehicles. However, without help from a system level intervention, the system cannot achieve overall system or global optimization. The approach also suffers limited sensing, storing, and computing capabilities.

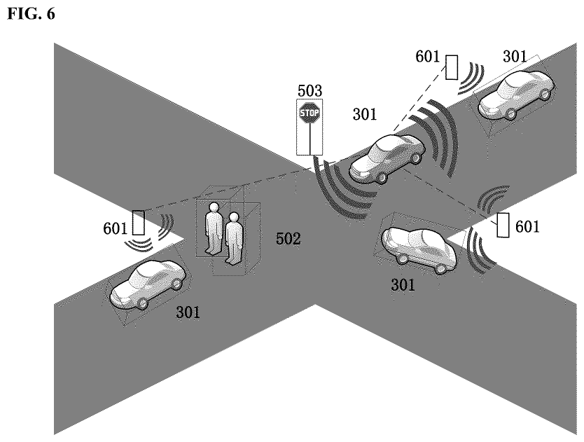

FIG. 6 shows exemplary V2V- and V2I-based approach comprising component 601: Roadside infrastructure facilitating communication. FIG. 6 shows how V2V- and V2I-based approach works. The approach has been employed for several years. Some prototypes have been developed. With V2V and V2I communications technologies, the system can make relatively better performance than individual autonomous vehicles. Each vehicle 301 receives the information detected by surrounding infrastructure 601 and other vehicles 301. The information includes cars, passengers, traffic situation, etc. With the provided information, a vehicle has an enhanced awareness of surrounding to make decisions. However, without help from a system level intervention, the system cannot achieve overall system or global optimization. The approach also suffers limited sensing, storing and computing capabilities.

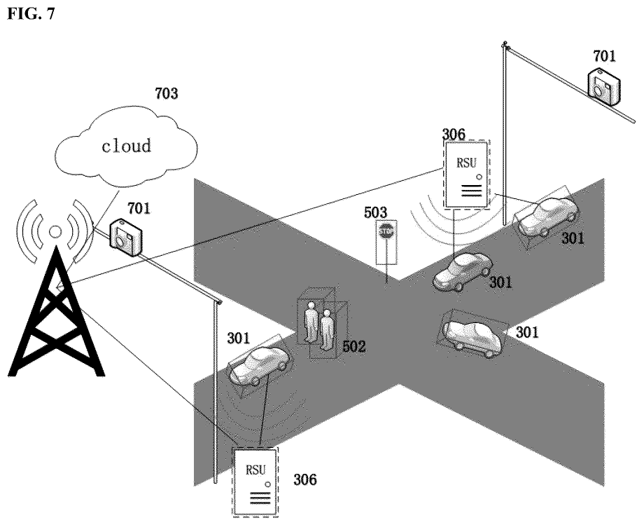

FIG. 7 shows an exemplary CAVH-IRIS approach. The system has the ability to make system-level optimum decisions, makes maneuvers to individual vehicles, and is beneficial for the overall transportation system. The system is configured with more powerful computing and storing capabilities but can suffer from limits in communication. The embodiment in FIG. 7 comprises components:
701—Roadside sensors.
702—Higher-level of IRIS.
703—Cloud: that assists data storage and computation.

FIG. 7 is a demonstration of the CAVH-IRIS approach. The RSU 306 in FIG. 7 uses sensors 701 on the road to senses the road, the vehicle 301, and the driving environment. The information is sent to higher level IRIS 702. The system, using the data from the sensors, can make system-level optimum decisions, can make maneuvers to individual vehicles, is beneficial for the overall transportation system. The system communicates with the OBU 302 to control the vehicles. The system can be configured with more powerful computing and storing capabilities by communicating with the cloud 703 as shown in FIG. 7.

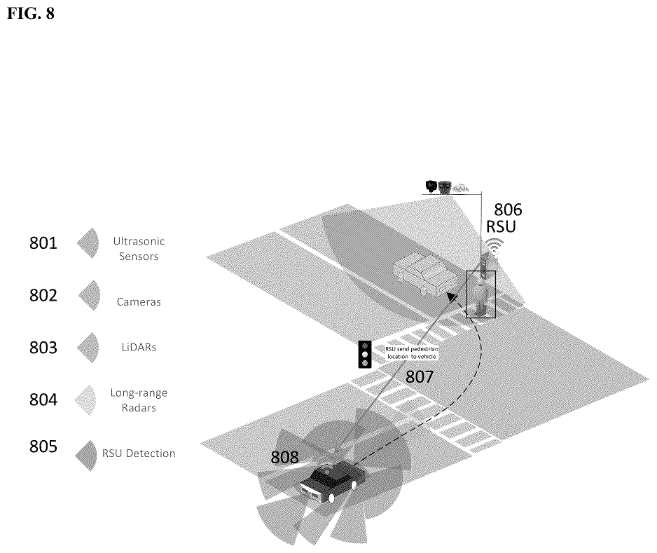

FIG. 8 shows an intelligence allocation example at Level 2 system intelligence comprising components:
801: Ultrasonic sensors on vehicle.
802: Cameras on vehicle.
803: LiDARs on vehicle.
804: Long-range radars on vehicle.
805: RSU detection area on vehicle.
806: Road side unit.
807: Communication between RSU and vehicle.
808: Vehicles in CAVH system.

FIG. 8 shows an example combination of intelligence distributed among the vehicle and infrastructure:
a) Sensing: The vehicle sub-system is the dominating part, which means the driving environment is primarily detected by sensors such as ultrasonic sensors 801, cameras 802, LiDARs 803, long-range radars 804 etc. that are located on the vehicle 808. Meanwhile, infrastructure sub-system 806 detects the traffic under the coverage area 805, and keeps communication with vehicle sub-system 807, and transmits the traffic information to complete the driving environment.
b) Transportation behavior prediction and management: Vehicle sub-system is the dominating part. The infrastructure sub-system mainly coordinates with the vehicle sub-system. It can predict the event from the macroscopic level, such as a long-distance traffic jam.
c) Planning and decision making: The vehicle sub-system is the major component. However, the infrastructure sub-system can suggest optimizing the system from the global perspective.
d) Vehicle control: The vehicle sub-system is the major component. The infrastructure sub-system only gives simple control commands that are judged by the vehicle sub-system. If the control command of two sub-systems conflict, the vehicle follows the instruction sent from the vehicle-subsystem. The system reports and stores the conflict event.

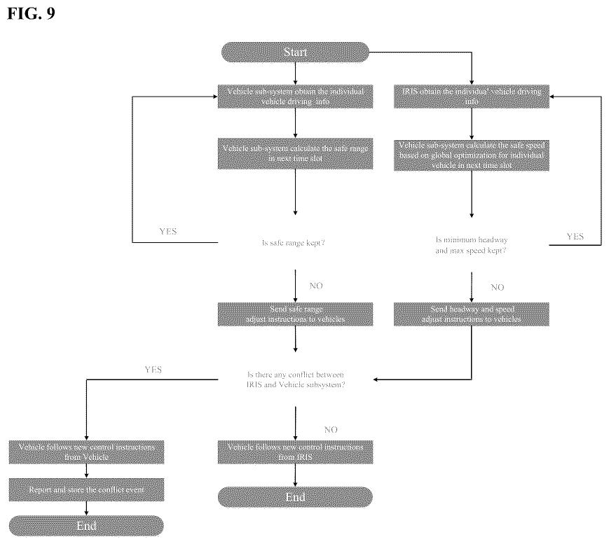

FIG. 9 shows that under the intelligence allocation method 2 above, vehicle sub-systems play a dominating role. Under this circumstance, vehicle-subsystems give a safety range to control the vehicle, and the IRIS sub-system gives its control command from the global perspective. The instruction from the IRIS must meet the safety range that are given by the vehicle. Otherwise, the vehicle follows the instruction sent from the vehicle sub-system. A conflicts record is stored and reported.

We claim:

1. An autonomous vehicle (AV) control system, comprising:
a vehicle subsystem comprising a vehicle, said vehicle comprising an onboard unit (OBU), and said OBU comprising a vehicle control component, wherein said vehicle subsystem operates at a vehicle intelligence level V; and
a cloud platform, wherein said cloud platform operates at an infrastructure intelligence level I,
wherein:
said AV control system operates at a variable system intelligence level S=1, 2, 3, 4, or 5 during vehicle operation by:
identifying the vehicle intelligence level V of said vehicle subsystem during vehicle operation and identifying the infrastructure intelligence level I of said cloud platform during vehicle operation; and
using the vehicle control component to allocate functions and intelligence to the vehicle subsystem and to the cloud platform to provide said AV control system with system intelligence S so that the AV control system manages the cloud platform and the vehicles to facilitate vehicle operations and controls during vehicle operation,
wherein identifying the vehicle intelligence level V of said vehicle subsystem during vehicle operation comprises:
identifying vehicle intelligence level V=0 for a vehicle providing no automation functions during operation;
identifying vehicle intelligence level V=1 for a vehicle providing assistance for controlling a vehicle during operation;
identifying vehicle intelligence level V=2 for a vehicle providing assistance for controlling a vehicle and comprising sensing functions during operation;
identifying vehicle intelligence level V=3 for a vehicle providing sensing functions that sense the environment in detail and in real-time and providing management of driving tasks during operation;
identifying vehicle intelligence level V=4 for a vehicle that drives autonomously for some conditions during operation; and/or
identifying vehicle intelligence level V=5 for a vehicle that drives autonomously for all conditions during operation.

2. The AV control system of claim 1, wherein said vehicle control component executes time-sensitive vehicle control instructions to control vehicle longitudinal and lateral position; speed; steering; and control.

3. The AV control system of claim 1, further comprising a traffic control center/traffic control unit (TCC/TCU) communication link providing communication between the AV control system and a traffic control center (TCC) and/or between the AV control system and a traffic control unit (TCU).

4. The AV control system of claim 3, wherein said TCU and/or TCC comprises a TCU/TCC control component that generates time-sensitive vehicle control instructions and provides the time-sensitive vehicle control instructions to the OBU,
wherein said time-sensitive vehicle control instructions comprise instructions for vehicle longitudinal and lateral position; speed; steering; and control.

5. The AV control system of claim 1, wherein said cloud platform is configured to provide storage as a service, control as a service, computing as a service, and/or sensing as a service.

6. The AV control system of claim 1, wherein using the vehicle control component to allocate functions and intelligence to the vehicle subsystem and to the cloud platform comprises allocating sensing functions to the vehicle subsystem and to the cloud platform.

7. The AV control system of claim 1, wherein using the vehicle control component to allocate functions and intelligence to the vehicle subsystem and to the cloud platform comprises allocating transportation behavior prediction and management functions to the vehicle subsystem and to the cloud platform.

8. The AV control system of claim 1, wherein using the vehicle control component to allocate functions and intelligence to the vehicle subsystem and to the cloud platform comprises allocating planning and decision-making functions to the vehicle subsystem and to the cloud platform.

9. The AV control system of claim 1, wherein using the vehicle control component to allocate functions and intelligence to the vehicle subsystem and to the cloud platform comprises allocating vehicle control functions to the vehicle subsystem and to the cloud platform.

10. The AV control system of claim 1, wherein identifying said infrastructure intelligence level I of said cloud platform during vehicle operation comprises:
identifying infrastructure intelligence level I=0 for a cloud platform providing no functions;
identifying infrastructure intelligence level I=1 for a cloud platform providing aggregated traffic data collection and planning and decision making to support traffic management;
identifying infrastructure intelligence level I=2 for a cloud platform providing sensing functions for pavement condition detection and vehicle kinematics detection for a portion of traffic and providing traffic information and vehicle control suggestions and instructions for vehicles through I2X communication;
identifying infrastructure intelligence level I=3 for a cloud platform providing individual vehicles with information describing the dynamics of surrounding vehicles and other objects, providing full automated driving on CAVH-compatible vehicle dedicated lanes, and providing transportation behavior prediction;
identifying infrastructure intelligence level I=4 for a cloud platform providing detailed driving instructions to control vehicles; and/or
identifying infrastructure intelligence level I=5 for a cloud platform providing full control and management for individual vehicles and provides full active safety functions for vehicles.

11. An autonomous vehicle (AV) control system, comprising:
a vehicle subsystem comprising a vehicle, said vehicle comprising an onboard unit (OBU), and said OBU comprising a vehicle control component, wherein said vehicle subsystem operates at a vehicle intelligence level V; and
a cloud platform, wherein said cloud platform operates at an infrastructure intelligence level I,
wherein:
said AV control system operates at a system intelligence level S=1, 2, 3, 4, or 5 during vehicle operation by:
identifying the vehicle intelligence level V of said vehicle subsystem during vehicle operation and identifying the infrastructure intelligence level I of said cloud platform during vehicle operation; and
using the vehicle control component to allocate functions and intelligence to the vehicle subsystem and to the cloud platform to provide said AV control system with system intelligence S so that the AV control system manages the cloud platform and the vehicles to facilitate vehicle operations and controls during vehicle operation.

12. The AV control system of claim 11, wherein said vehicle control component executes time-sensitive vehicle control instructions to control vehicle longitudinal and lateral position; speed; steering; and control.

13. The AV control system of claim 11, wherein said cloud platform comprises a cloud control component that generates time-sensitive vehicle control instructions and provides the time-sensitive vehicle control instructions to the OBU, wherein said time-sensitive vehicle control instructions comprise instructions for vehicle longitudinal and lateral position; speed; steering; and control.

14. The AV control system of claim 11, wherein using the vehicle control component to allocate functions and intelligence to the vehicle subsystem and to the cloud platform comprises allocating sensing functions to the vehicle subsystem and to the cloud platform.

15. The AV control system of claim 11, wherein using the vehicle control component to allocate functions and intelligence to the vehicle subsystem and to the cloud platform comprises allocating transportation behavior prediction and management functions to the vehicle subsystem and to the cloud platform.

16. The AV control system of claim 11, wherein using the vehicle control component to allocate functions and intelligence to the vehicle subsystem and to the cloud platform comprises allocating planning and decision-making functions to the vehicle subsystem and to the cloud platform.

17. The AV control system of claim 11, wherein using the vehicle control component to allocate functions and intelligence to the vehicle subsystem and to the cloud platform comprises allocating vehicle control functions to the vehicle subsystem and to the cloud platform.

18. The AV control system of claim 11, wherein identifying the vehicle intelligence level V of said vehicle subsystem during vehicle operation comprises:
identifying vehicle intelligence level V=0 for a vehicle providing no automation functions during operation;
identifying vehicle intelligence level V=1 for a vehicle providing assistance for controlling a vehicle during operation;
identifying vehicle intelligence level V=2 for a vehicle providing assistance for controlling a vehicle and comprising sensing functions during operation;
identifying vehicle intelligence level V=3 for a vehicle providing sensing functions that sense the environment in detail and in real-time and providing management of driving tasks during operation;
identifying vehicle intelligence level V=4 for a vehicle that drives autonomously for some conditions during operation; and/or
identifying vehicle intelligence level V=5 for a vehicle that drives autonomously for all conditions during operation.

19. The AV control system of claim 11, wherein identifying said infrastructure intelligence level I of said cloud platform during vehicle operation comprises:
identifying infrastructure intelligence level I=0 for a cloud platform providing no functions;
identifying infrastructure intelligence level I=1 for a cloud platform providing aggregated traffic data collection and planning and decision making to support traffic management;
identifying infrastructure intelligence level I=2 for a cloud platform providing sensing functions for pavement condition detection and vehicle kinematics detection for a portion of traffic and providing traffic information and vehicle control suggestions and instructions for vehicles through I2X communication;
identifying infrastructure intelligence level I=3 for a cloud platform providing individual vehicles with information describing the dynamics of surrounding vehicles and other objects, providing full automated driving on CAVH-compatible vehicle dedicated lanes, and providing transportation behavior prediction;
identifying infrastructure intelligence level I=4 for a cloud platform providing detailed driving instructions to control vehicles; and/or
identifying infrastructure intelligence level I=5 for a cloud platform providing full control and management for individual vehicles and provides full active safety functions for vehicles.

20. The AV control system of claim 11, wherein said cloud platform is configured to provide storage as a service, control as a service, computing as a service, and/or sensing as a service.
